(19) United States
(12) Patent Application Publication
(10) Pub. No.: US 2009/0223579 A1
(43) Pub. Date: Sep. 10, 2009

(54) WATER FLOW CONTROL DEVICE

(76) Inventor: Phillip Bautch, Hudson, WI (US)

Correspondence Address: LAW OFFICES OF EUGENE M. CUMMINGS, P.C., ONE NORTH WACKER DRIVE, SUITE 4130, CHICAGO, IL, 60606, US

(21) Appl. No.: 12/400,931

(22) Filed: Mar. 10, 2009

Related U.S. Application Data
(60) Provisional application No. 61/068,836, filed on Mar. 10, 2008.

(51) Int. Cl. F15C 4/00; B23P 11/00

(52) U.S. Cl. 137/561 R; 29/428

(57) ABSTRACT

A water flow control device for installation between a water supply line and a nozzle, shower head or the like, whereby the water flow control device comprises a handle member connected to a valve member for controlling the flow of water between full flow and reduced flow, whereby the assembly and installation of the water flow control device ensures that the handle to control the water flow is oriented the same way for every installation.

### RELATED APPLICATION

This application claims the benefit of U.S. Provisional Application No. 61/068,836, filed Mar. 10, 2008.

### FIELD OF THE INVENTION

The present invention relates generally to an improved water flow control device and a method of installation thereof. More specifically, this invention relates to an improved water flow control device mounted between a water supply line and a nozzle enabling a user to regulate the amount of water flowing through the control device.

### DESCRIPTION OF THE PRIOR ART

Water flow control devices, in particular for reducing the water flow in shower applications are known in the art and are used to help preserve water and save energy related to heating the water. For example, U.S. Pat. No. 4,191,332 to De Langis et al. discloses a shower head flow control device comprising a push/pull rod type valve mechanism for on/off control of the water flow. U.S. Pat. No. 5,613,639 to Storm et al. discloses an on/off control valve for showers using a cylindrical rod type valve mechanism. U.S. Pat. No. 4,522,232 to Ferguson discloses a shower flow controller comprising a horseshoe-shaped handle to allow the user to change the amount of water supplied to the shower head. U.S. Pat. No. 5,123,628 to Yu discloses a water saving valve comprising a spool rod type mechanism rotatable by a handle to regulate the quantity of water allowed to flow through the showerhead. U.S. Pat. No. 6,565,018 to Degeyter discloses a shower flow control device comprising a lever connected to a valve for quickly shutting off the flow of water through a shower head.

While these devices fulfill their respective, particular objectives and requirements, the aforementioned patents all possess shortcomings that, if addressed, would prove beneficial to users of such devices. All prior art devices use some kind of lever or handle to manipulate a valve for regulating the amount of water that can flow through the device. However, all prior art water flow control devices leave the orientation of their levers or handles in relation to the user to chance. Typically, an installer will screw a water flow control device onto a water supply line until a snug and leak free fit is achieved, with no regard to the orientation of the handle. In the prior art, in relation to the user, the handle may end up to the left, to the right, on top, or underneath the shower head or anywhere in between. The orientation of the handle can be different every time it is installed.

In addition, many of the prior art devices allow the user to completely stop the flow of water before it reaches the nozzle or shower head even though the water may still be turned on at the main valves. If a user inadvertently forgets to also shut of the main valves, the water line between the main valves and the water flow control device could be left in a pressurized condition for potentially a long period of time. However, typical water supply lines are not intended to be left in a pressurized condition for any period of time and there is a strong possibility that leaks in the supply line may develop causing substantial water damage.

Furthermore, many prior art devices do not provide for an area on the handle or lever to apply text or graphics, which, for example, could be used for operating instructions or a marketing message. Especially the lack of instructive text or graphics in close proximity to the device limits the prior art devices' effectiveness in public areas.

Still further, many prior art devices comprise many parts and are therefore rather expensive to manufacture and cannot be installed without the use of tools.

### OBJECTS OF THE INVENTION

Accordingly, it is an object of this invention to provide an improved water flow control device that can be easily and cost-efficiently manufactured and that is easily mounted between a water supply line and a nozzle or shower head, whereby the water flow control device only comprises three separate main components and a total of five separate parts.

Another object of this invention is to provide for an improved water flow control device that enables a user to regulate the amount of water flowing through the device from a full flow condition to a reduced flow condition, whereby the device further prevents the user to completely shut off the flow of water to avoid the build-up of undesirable pressure inside the water supply line, and to prevent water from accumulating inside the water supply line where it would cool down below the temperature selected by the user at the main valves, causing a blast of cold water to come out of the nozzle once a full flow condition is reinstated.

Yet another object of this invention is to provide for an improved water flow control device, wherein the handle member comprises a display area for a text and/or graphical display.

Another object of this invention is to provide for a method of installing a water flow control device that ensures the correct, i.e., upright/vertical orientation of the handle member at every installation, whereby the front side of the handle faces the user and is located substantially over the shower head.

Yet another object of this invention is to provide for an improved water flow control device and method of installation thereof that promotes more widespread use of the device in public areas.

Still another object of the invention is to provide for an improved water flow control device that avoids unnecessary waste of water thereby preserving a limited natural resource as well as saving energy necessary to heat the water.

These and other objects and advantages of this invention will be apparent from the detailed description and drawings. What follows is a preferred embodiment of the present invention. To assess the full scope of the invention the claims should be looked to as the preferred embodiment is not the only embodiment within the scope of the invention.

### SUMMARY OF THE INVENTION

The disclosed invention achieves its objectives by providing an improved water flow control device and a method of installation thereof. The present invention comprises a water flow control device for installation between a water supply line and a nozzle, shower head or the like, whereby its assembly and installation ensures that the handle to control the water flow is oriented the same way for every installation.

In one aspect of the invention an improved water flow control device is disclosed. More particularly, the improved water flow control device is adapted to be installed between a water supply line and a nozzle or shower head. The improved water flow control devices comprises a housing having an input end and an output end, said input end having an internal thread for coupling to the water supply line and said output end having an external thread for coupling to the nozzle, said housing further having a first bore connecting said input end and said output end, and between said input end and said output having a second bore perpendicular to and intersecting said first bore; a valve member having a third bore, said valve member rotatably disposed within said second bore; and a handle member removably coupled to said valve member for rotating said valve member between a full flow position and a reduced flow position.

In another aspect of the disclosed invention a method of installing a water flow control device is disclosed, wherein the method comprises the steps of coupling said input end of said housing to a water supply line; aligning said first bore of said housing substantially parallel to a horizontal plane; inserting a valve member into said second bore; and removably coupling a handle member to said valve member.

### BRIEF DESCRIPTION OF THE DRAWINGS

Although the characteristic features of this invention will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 shows a perspective view of the fully assembled preferred embodiment of the water flow control device of the present invention mounted between a water supply line and a shower head;

FIG. 2 shows a cross-sectional side view of the valve housing of the water flow control device of FIG. 1;

FIG. 3 shows a cross-sectional front view of the valve member of the water flow control device of FIG. 1;

FIG. 3a shows a cross-sectional side view of the valve member of the water flow control device of FIG. 1;

FIG. 4 shows a rear view of the handle member of the water flow control device of FIG. 1;

FIG. 4a shows a cross-sectional side view of the handle member of FIG. 4;

FIG. 5 shows a cross-sectional rear view of the water flow control device in an full flow condition;

FIG. 6 shows a cross-sectional side view of the water flow control device in an full flow condition;

FIG. 7 shows a side view of the fully assembled water flow control device in a reduced flow condition;

FIG. 8 shows a cross-sectional front view of the water flow control device in a reduced flow condition;

FIG. 9 shows a cross-sectional side view of the water flow control device in a reduced flow condition;

FIGS. 10a, 10b and 10c illustrate the method of installing the three components of the water flow control device in the preferred embodiment.

### DETAILED DESCRIPTION OF THE ILLUSTRATED EMBODIMENT

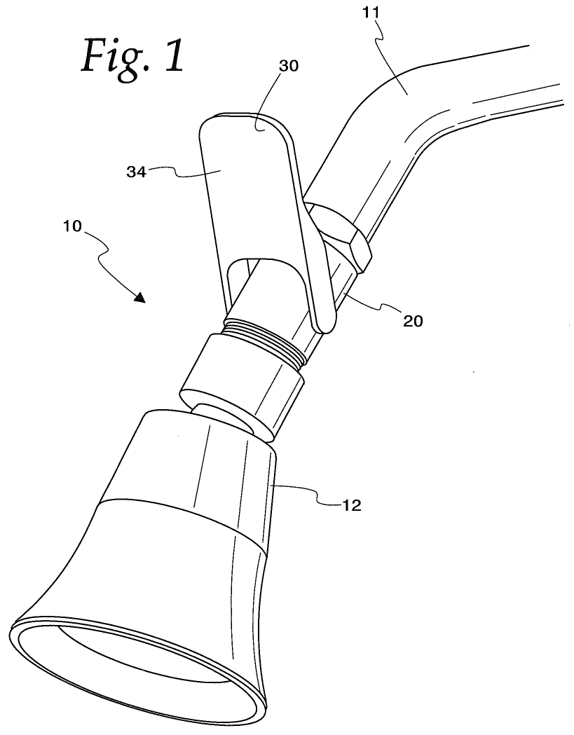

Turning now to the Figures, FIG. 1 is illustrative of a preferred water flow control device assembly 20 to control the amount of water flowing through the device incorporating the features of the present invention. In particular, it shows water flow control device 20 fully assembled and installed as part of shower system 10, whereby water flow control device 20, having a handle member 30 and a display area 34 is mounted between water supply line 11 and shower head 12.

### A. The Components of the Water Flow Control Device

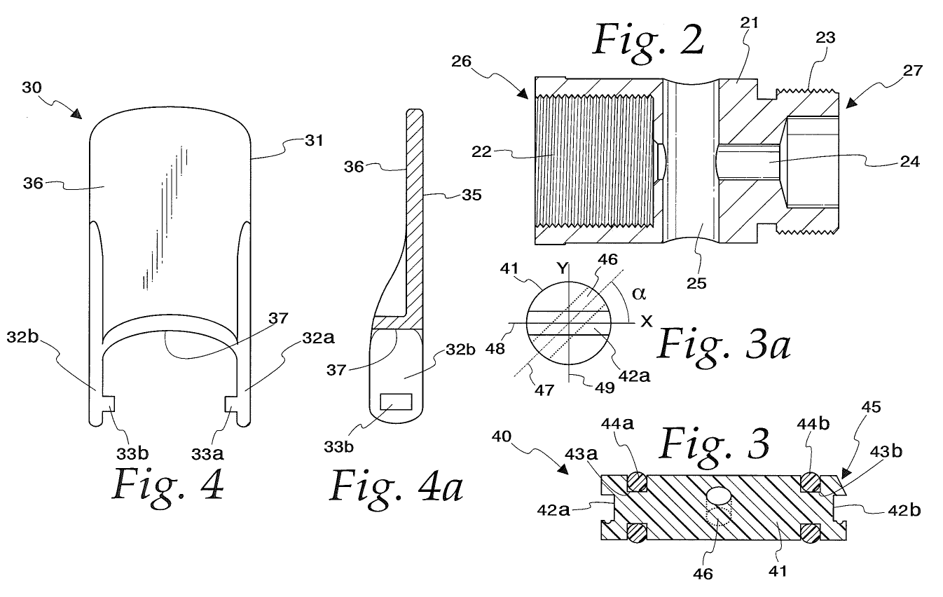

FIGS. 2 through 4a show in detail the three components of the disclosed water flow control device 20, that is, a housing, a valve member, and a handle member. Turning first to FIG. 2, FIG. 2 shows a cross-sectional view of a preferred embodiment of housing 21 having on one side an input end 26 through which, when connected to a water supply line, water will flow into the device, and on the opposite side, an output end 27 through which water will flow out of the device. Input end 26 further having an internal thread 22 and output end 27 further having an external thread 23. Housing 21 also includes a water pathway 24 located therein and extending through the length of housing 21 from input end 26 to output end 27 for allowing the water to flow through the device. Housing 21 further comprising bore 25 located between input end 26 and output end 27, whereby bore 25 intersects water pathway 24 in a perpendicular orientation.

FIG. 3 shows a cross-sectional front view of a preferred embodiment of valve member 40. Valve member 40 having a cylindrical-shaped valve body 41 with an orifice 46 located in the center of valve body 41. Valve body 41 further having a left slot 42a and a right slot 42b located at either one of the respective ends of valve body 41. Located near each of the two ends of valve body 41 are recesses 43a and 43b for supporting o-rings 44a and 44b, respectively. Furthermore, in the preferred embodiment of valve member 40, at least one of the ends of valve body 41 includes a beveled or tapered surface 45 to facilitate the mounting of handle member 30 (shown in FIGS. 4 and 4a). FIG. 3 shows tapered surface 45 on the side of right slot 42b.

To further facilitate the installation of handle member 30 (shown in FIGS. 4 and 4a), in another embodiment (not shown) of valve member 40, one end of valve body 41 would have a larger diameter than the other end of valve body 41. In this embodiment, the ends of bore 25 near the outer surface of housing 21 would have to be counter sunk to a diameter appropriate for receiving and accommodating the larger diameter end of valve body 41. During the installation of handle member 30, the counter sink would prevent the handle prong from pushing the valve member through bore 25, thereby exposing too much of the other end of valve member 41 past the surface of valve housing 21 making it more difficult to engage the tab of the handle prong with the slot of valve member 41. Counter-sinking both ends of bore 25 to accommodate the larger diameter end of valve body 41 preserves the 90 degree turn of adjustment in order to align bore 25 parallel to a horizontal plane, as described below in the section regarding the installation of the water flow control device of this invention.

Referring now to FIG. 3a, FIG. 3a shows a cross-sectional side view of the preferred embodiment of valve body 41, wherein centerline 47 of orifice 46 is offset with reference to vertical plane 49 and horizontal plane 48 of valve body 41, whereby vertical plane 49 is perpendicular to horizontal plane 48 of valve body 41. Horizontal plane 48 is further defined by and parallel to horizontally oriented left slot 42a and right slot 42b (not shown). More particularly, centerline 47 is oriented offset between vertical y-plane 49 and horizontal x-plane 48. In the preferred embodiment, centerline 47 of orifice 46 is offset by approximately 45 degrees. This offset orientation of orifice 46 within valve body 41 facilitates the alignment of orifice 46 with water pathway 24 between a full flow condition, when handle member 30 is moved forward until it comes into contact with housing 21 (as shown in FIG. 6 and further described below) and a reduced flow condition when handle member 30 is moved back until it comes into contact with housing (as shown in FIG. 9 and further described below). If the centerline 47 of orifice 46 would not be offset, between vertical plane 49 and horizontal plane 48, a full flow condition could not be achieved when handle member 30 is moved forward until it comes into contact with housing 21. It is understood that other orientations are possible as long as the orientation of orifice 46 within valve body 41 facilitates the creation of a full flow condition and a reduced flow condition in a final assembly of water flow control device 20, whereby it is preferred that a full flow condition be achieved when handle member 30 is moved forward until it comes into contact with housing 21 and a reduced flow condition be achieved when handle member 30 is moved back until it comes into contact with housing 21.

FIGS. 4 and 4a show a preferred embodiment of handle member 30, whereby FIG. 4a provides a cross-sectional view of handle member 30. Handle member 30 comprises a handle body 31 having a pair of handle prongs, i.e., left handle prong 32a and right handle prong 32b. Left and right handle prongs 32a and 32b each include corresponding protruding tabs, i.e., left tab 33a and right tab 33b for removably engaging with left slot 42a and right slot 42b, respectively, of valve body 41 shown in FIG. 3. Handle member 30 further having a front-side 35, a back-side 36 and an underside 37, whereby in the assembly of water flow control device 20, front-side 35 is oriented to face the user as shown in FIG. 1. The preferred embodiment of handle member 30 further having a display area 34 located on front-side 35 of handle member 30 for displaying text and/or graphics. For example, the text and/or graphics displayed on display area 34 may include instructions on how to operate water flow control device 20.

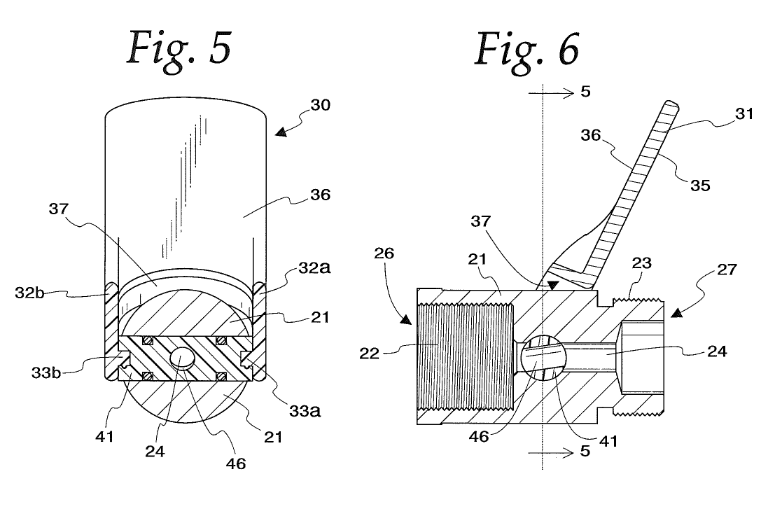

FIGS. 5 and 6 show a fully assembled preferred embodiment of water flow control device 20 in its full flow condition. During the operation of water flow control device 20, a user can control the amount of water that is allowed to flow through water flow control device 20 by manipulating handle member 30. With reference to FIG. 6, a cross-sectional side view of water flow control device 20, moving handle member 30 forward, i.e., towards output end 27 will cause orifice 46 in valve member body 41 to align with water pathway 24 in a manner that allows the most amount of water to enter housing 21 through input end 26 and to flow through orifice 46 and out through output end 27. More particularly, in its full flow condition, orifice 46 is aligned substantially parallel to water pathway 24. FIG. 5 shows a cross-sectional rear view of water flow control device 20 in its full flow condition, wherein orifice 46 and water pathway 24 are aligned in a manner allowing the most amount of water to pass through valve housing 21, i.e., substantially the entire diameter of orifice 46 is exposed towards both input end 26 and output end 27. In the preferred embodiment of water flow control device 20, the range of motion of handle member 30 is restricted by valve housing 21. For example, the full flow condition is achieved when the portion of handle underside 37 that is near handle front 35 comes in contact with valve housing 21, as shown in FIG. 6.

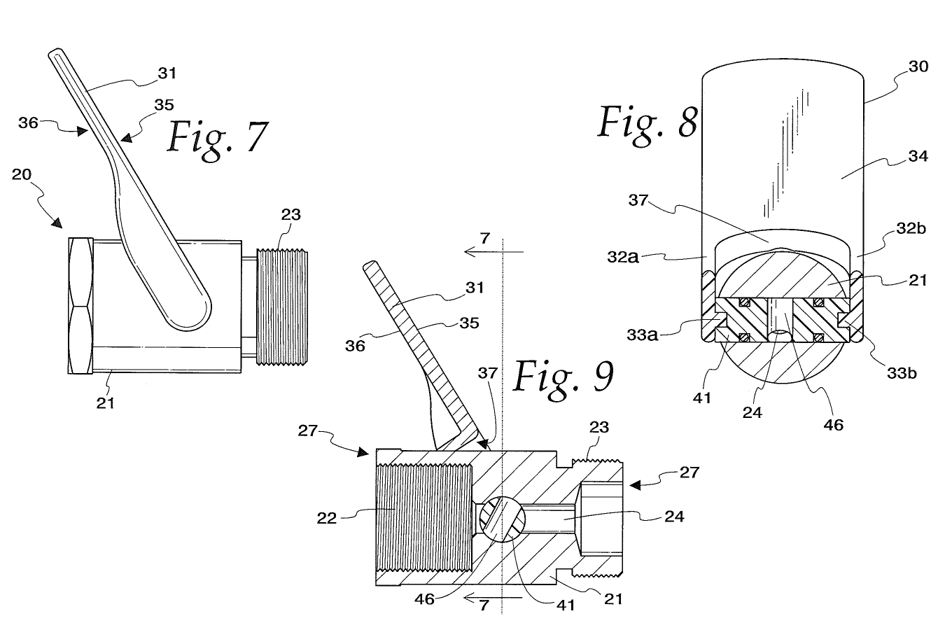

FIGS. 7 though 9 show a preferred embodiment of water flow control device 20 in its reduced flow condition, whereby FIG. 7 provides a side view of water control device 20 in its reduced flow condition. With reference to FIG. 9, a cross-sectional side view of water flow control device 20, moving handle member 30 towards the input end 26 will cause orifice 46 in valve member body 41 to align with water pathway 24 in a manner that allows the least amount of water to enter housing 21 through input end 26 and to flow through orifice 46 and out through output end 27. More particularly, and with reference to FIG. 8, showing a cross-sectional in its reduced flow condition, orifice 46 is aligned with water pathway 24 so as to create only a small opening through which water can enter orifice 46 from input end 26 and leave orifice 46 to output end 27. FIG. 8 shows a cross-sectional front view of water flow control device 20 in its full flow condition, wherein orifice 46 and water pathway 24 are aligned in a manner allowing the least amount of water to pass through valve housing 21, i.e., only a small fraction of the diameter of orifice 46 is exposed towards both input end 26 and output end 27. In the preferred embodiment of water flow control device 20, the range of motion of handle member 30 is restricted by valve housing 21. For example, the reduced flow position is achieved when the portion of handle underside 37 that is near handle back 36 comes in contact with valve housing 21, as shown in FIG. 9.

It should be noted that in the preferred embodiment of water flow control device 20, it is neither possible, nor desirable to completely stop the flow of water through housing 21. This is to prevent any possibility that a user may leave shower system 10 with the water turned on at the main valves (not shown), while completely stopping the flow of water only through water flow control device 20 near shower head 12. Doing so would leave water supply line 11 between the main valves and water flow control device 20 in a pressurized condition for potentially a long period of time. However, typical water supply lines are not intended to be left in a pressurized condition for any period of time and there is a strong possibility that leaks in the line may develop causing substantial water damage. Another advantage of not allowing the water flow to completely stop is that it prevents water from accumulating inside water supply line 11 where it would cool down below the temperature selected by the user at the main valves (not shown), causing a blast of cold water to come out of the nozzle or shower head 12 once a full flow condition is reinstated.

### B. The Installation of the Water Flow Control Device

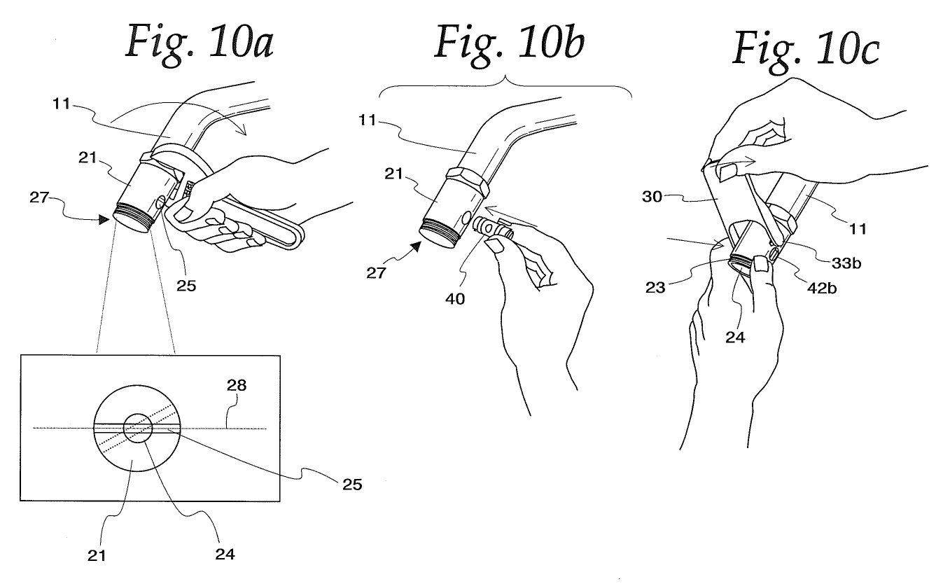

FIGS. 10a through 10c illustrate the claimed method of installing water flow control device 20 between water supply line 11 and shower head 12 (as shown in FIG. 1) in order to ensure the correct orientation of water flow control device 20 for every installation.

Referring first to FIG. 10a, after having removed shower head 12 (not shown) from water supply line 11, the installer first screws housing 21 onto water supply line 11 until a snug fit is achieved. More particularly, input end 26 with internal thread 22 is screwed onto the external thread of water supply line 11 leaving external thread 27 exposed to receive the internal thread of showerhead 12 (not shown). When installing shower heads and faucets, water control devices and other plumbing devices, it is common to apply plumbing tape onto the external threads of a line or device to facilitate an installation free of water leaks.

As pointed out above, prior art water flow control devices leave the orientation of their handles in relation to the user to chance. Typically, an installer will screw a water flow control device onto a water supply line until a snug and leak free fit is achieved, with no regard to the orientation of the handle. In the prior art, in relation to the user, the handle may end up to the left, to the right, on top, or underneath the shower head or anywhere in between.

Therefore, when mounting housing 21 to water supply line 11 it is critical to correctly orient housing 21 with reference to the user. More particularly, the housing should be oriented in a way that after the assembly of water control device 21 is completed, handle 30 is upright at a substantially 90 degree angle relative to the (horizontal) floor or some other horizontal reference line. When screwing a device, such as a water flow control device to a water supply line, especially if plumbing tape is applied to the external thread of the water supply line, the installer can screw the device to a snug fit and normally still has a 90 degree turn of adjustment available without compromising a leak free fit. Because the housing 21 is mounted to water supply line 11 prior to mounting handle 30 to valve member 40 disposed inside bore 25 of valve housing 21, the installer is still able to take full advantage of the available 90 degree turn of adjustment to properly orient housing 21.

In order to ensure that handle 30 will be positioned upright at a substantially 90 degree angle relative to the (horizontal) floor, the installer must, within the available 90 degree turn of adjustment, horizontally align both bore 25 of housing 21 with the (horizontal) floor or some other horizontal reference line 28 as shown in the detail drawing to FIG. 10a. The fact that handle 30 is not attached to water flow control device 20 until after housing 21 has been mounted and properly oriented is a critical improvement over the prior art, because fully assembled prior art devices may not be able to benefit from the available 90 degree turn of adjustment in order to obtain the preferred orientation of the handle member. A prior art device may end up with its handle underneath the shower head, and a 90 degree turn of adjustment is insufficient to correctly orient the handle.

In a next step, as shown in FIG. 10b, the installer may insert valve body 40 into bore 25 of housing 21. However, the sequence is not critical and an installer may also insert valve body 40 before mounting housing 21 to water supply line 11 without compromising the proper orientation of handle 30. Yet, what is critical is correct insertion of valve body 40 into bore 25, to ensure that the handle 30 can achieve the desired full flow condition or reduced flow condition. Consequently, valve body 40 should be inserted so that when valve body 40 is disposed inside of bore 25, from the perspective of a user facing output end 27 of mounted housing, left slot 42a is on the left side of housing 21 and right slot 42b is on the right side of housing 21. Furthermore, in the preferred embodiment of tapered surface 45 must be located on top of right slot 42b and on the right side of housing 21 from the perspective of a user facing output end 27, in order to assure correct orientation of valve body 40 and orifice 46 inside bore 25.

In a final step, as shown in FIG. 10c, the installer attaches handle 30 to water flow control device 20 by engaging left tab 33a of left handle prong 32a with left slot 42a of valve body 40 and then sliding right handle prong 32b over housing 21 to engage right tab 33b of right handle prong 32b with right slot 42b. While the particular sequence is not critical, to promote ease of installation, the installer may prefer to first engage left tab 33a with left slot 32a and then right tab 33b with right slot 42b. Furthermore, tapered surface 45 may further facilitate the engagement of right tab 33b with right slot 42b.

After full assembly of water flow control device 20, the installer may mount shower head 12 to water flow control device 20 by screwing shower head 12 onto external thread 27. The completed installation is shown if FIG. 1.

While FIGS. 1-10c illustrate only one design of a water flow control device used by the preferred embodiment of the present invention, it should be understood that different sizes and shapes are obviously a matter of design choice. The improvements of the present invention can be incorporated in a variety of designs.

The foregoing description of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

What is claimed is:

1. A water flow control device, adapted to be installed between a water supply line and a nozzle, the device comprising:
a housing having an input end and an output end, said input end having an internal thread for coupling to the water supply line and said output end having an external thread for coupling to the nozzle, said housing further having a first bore connecting said input end and said output end, and between said input end and said output having a second bore perpendicular to and intersecting said first bore;
a valve member having a third bore, said valve member rotatably disposed within said second bore; and
a handle member removably coupled to said valve member for rotating said valve member between a full flow position and a reduced flow position.

2. The water flow control device of claim 1, wherein said valve member has a first end portion and a second end portion, and wherein said handle member has a first prong and a second prong, said first prong adapted to be removably coupled to said first end portion of said valve member disposed in said second bore, said second prong adapted to be removably coupled to said second end portion of said valve member.

3. The water flow control device of claim 1, wherein said handle member when removably coupled to said valve member is adapted to rotatably move said valve member from a full flow position to a reduced flow position by varying the alignment between said third bore in said valve member and said first bore in said housing.

4. The water flow control device of claim 1, wherein the range of said rotatable movement of said valve member between said full flow and said reduced flow positions is defined and restricted by at least a portion of said handle member coming in contact with said housing preventing further rotation of said valve member.

5. The water flow control device of claim 1, wherein said input end of said housing is coupled to said water supply line before said handle member is removably coupled to said valve member disposed in said second bore of said valve housing.

6. The water flow control device of claim 5, wherein coupling said housing to said water supply line includes aligning said first bore substantially parallel to a horizontal plane before said handle member is removably coupled to said valve member resulting in said removably coupled handle member being oriented substantially perpendicular to said horizontal plane.

7. The water flow control device of claim 1, wherein the centerline of said third bore in said valve member is offset between a vertical plane and a horizontal plane of said valve member.

8. The water flow control device of claim 1, wherein said handle member has a front side and a back side and wherein said front side comprises a display area for text and/or graphical display.

9. The water flow control device of claim 2, wherein said valve member comprises a tapered surface on at least one of said first and second end portions.

10. The water flow control device of claim 1, wherein said valve member has a larger diameter on at least one of said first and second end portions.

11. The water flow control device of claim 10, wherein said second bore comprises a countersink on either end of said second bore to receive said end portion of said valve member having said larger diameter.

12. The water flow control device of claim 1, wherein said nozzle is a shower head

13. A method of installing a water flow control device, said water flow control device having a housing with an input end and an output end connected by a first bore extending therethrough, said housing between said input end and said output end further having a second bore perpendicular to and intersecting said first bore, the method comprising the steps of:
coupling said input end of said housing to a water supply line;
aligning said first bore of said housing substantially parallel to a horizontal plane;
inserting a valve member into said second bore; and
removably coupling a handle member to said valve member.

14. The method of claim 12, wherein the step of removably coupling said handle member to said vale member includes orienting said handle member substantially perpendicular to a horizontal plane in an upright position, whereby the front side of said handle member faces the user.
